(19) United States
(12) Patent Application Publication
(10) Pub. No.: US 2026/0357967 A1
(43) Pub. Date: Nov. 12, 2026

(54) AUTOMOTIVE LAMP WITH COLLIMATORS, PRISMS, AND LIGHT EXTRACTORS

(71) Applicant: Autosystems, a division of Magna Exteriors Inc., Aurora (CA)

(72) Inventors: Edward BAILEY, Rochester Hills, MI (US); Justin F. LUMLEY, Westland, MI (US)

(21) Appl. No.: 19/665,661

(22) Filed: May 1, 2026

Related U.S. Application Data
(60) Provisional application No. 63/801,463, filed on May 7, 2025.
(60) Provisional application No. 63/911,047, filed on Nov. 4, 2025.

(51) Int. Cl. F21S 43/20; F21S 43/14; F21S 43/31; F21S 45/48; F21V 23/00; F21W 103/35; F21Y 105/10; F21Y 113/13

(52) U.S. Cl. CPC F21S 43/26231; F21S 43/14; F21S 43/26211; F21S 43/26241; F21S 43/26271; F21S 43/26411; F21S 43/281; F21S 43/31; F21S 45/48; F21V 23/003; F21W 2103/35; F21Y 2105/10; F21Y 2113/13

(57) ABSTRACT

An exterior lighting assembly for a vehicle includes: an array of pixel light sources disposed on a backplane, a secondary optic element overlying the array of pixel light sources, and an outer lens overlying and spaced apart from the secondary optic element. Each of the pixel light sources includes at least one LED device and a lenslet encapsulating the at least one LED device.

### CROSS REFERENCE TO RELATED APPLICATIONS

This utility patent application claims priority to and the benefit of U.S. Provisional Patent Application No. 63/801,463 filed May 7, 2025 and U.S. Provisional Patent Application No. 63/911,047 filed Nov. 4, 2025, the contents of which are each incorporated herein by reference in their entirety

### FIELD

The present disclosure relates generally to lighting for motor vehicles. More specifically, the present disclosure relates to signal lights for passenger vehicles, such as cars and trucks.

### BACKGROUND

This section provides background information related to the present disclosure which is not necessarily prior art.

As per new and futuristic trends in modern day Automotive lighting, applications of human-vehicle interaction are growing steadily, leading to a demand for automotive lighting with more advanced lighting effects. There are also limitations on automotive lighting components, such as light intensity requirements, durability, and cost. There is a significant demand to provide lighting systems and lighting assemblies that generate advanced lighting effects, such as animations and complex patterns, and without the use of complex and expensive electronic components.

### SUMMARY

This section provides a general summary of the disclosure, and is not a comprehensive disclosure of its full scope or all of its features.

The present disclosure provides an exterior lighting assembly for a vehicle. The exterior lighting assembly includes: an array of pixel light sources disposed on a backplane, a secondary optic element overlying the array of pixel light sources, and an outer lens overlying and spaced apart from the secondary optic element. Each of the pixel light sources includes at least one LED device and a lenslet encapsulating the at least one LED device.

The present disclosure also provides a taillight assembly for a vehicle. The taillight assembly includes: an array of pixel light sources disposed on a backplane, and a secondary optic element overlying the array of pixel light sources. Each of the pixel light sources includes at least one LED device and a lenslet encapsulating the at least one LED device.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 shows a side view of a vehicle.

FIG. 2 shows a schematic block diagram of a vehicle with a lighting system, in accordance with an aspect of the present disclosure.

FIG. 3 shows a signal lamp assembly for a vehicle, in accordance with an aspect of the present disclosure.

FIG. 3A shows the signal lamp assembly of FIG. 3 in an unlit (hidden) state, in accordance with an aspect of the present disclosure.

FIG. 4 shows a graph illustrating light spectra for various different light sources, in accordance with an aspect of the present disclosure.

FIG. 5 shows a schematic diagram illustrating a cross-section of a first LED pixel assembly, in accordance with an aspect of the present disclosure.

FIG. 6 shows a schematic diagram illustrating a cross-section of a second LED pixel assembly, in accordance with an aspect of the present disclosure.

FIG. 7 shows a schematic diagram illustrating a cross-section of a third LED pixel assembly, in accordance with an aspect of the present disclosure.

FIG. 8 shows a schematic diagram illustrating a cross-section of a fourth LED pixel assembly, in accordance with an aspect of the present disclosure.

FIG. 9 shows a schematic diagram illustrating a cross-section of a fifth LED pixel assembly, in accordance with an aspect of the present disclosure.

FIG. 10 shows a schematic diagram illustrating a cross-section of a lamp assembly for a vehicle, in accordance with an aspect of the present disclosure.

FIG. 11 shows a perspective view of a section of a secondary optic element with a plurality of convex collimators, in accordance with an aspect of the present disclosure.

FIG. 12 shows a perspective view of a section of the secondary optic element including a front surface opposite of the plurality of convex collimators, in accordance with an aspect of the present disclosure.

FIG. 13 shows a cross-sectional view of an exterior lighting assembly for a vehicle, in accordance with an aspect of the present disclosure.

FIGS. 14-18 show enlarged cross-sections of the exterior lighting assembly of FIG. 13.

FIG. 19 shows beam profiles generated by the exterior lighting assembly, without and with the prisms of the secondary optic element.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms "a,” "an," and "the" may be intended to include the plural forms as well, unless the context clearly indicates otherwise. The terms "comprises," "comprising," “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being "on," “engaged to,” "connected to," or "coupled to" another element or layer, it may be directly on, engaged, connected or coupled to the other element or layer, or intervening elements or layers may be present. In contrast, when an element is referred to as being "directly on," “directly engaged to,” "directly connected to," or "directly coupled to" another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term "and/or" includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” "beneath," "below," "lower," "above," "upper," and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below" or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

The present disclosure provides a device or related technology, such as a lighting assembly for a vehicle with light extraction lenslets for a mini-LED display used in tandem with a secondary optic element, as described herein. The present disclosure also provides a taillight assembly for a vehicle, including any combination of features described herein.

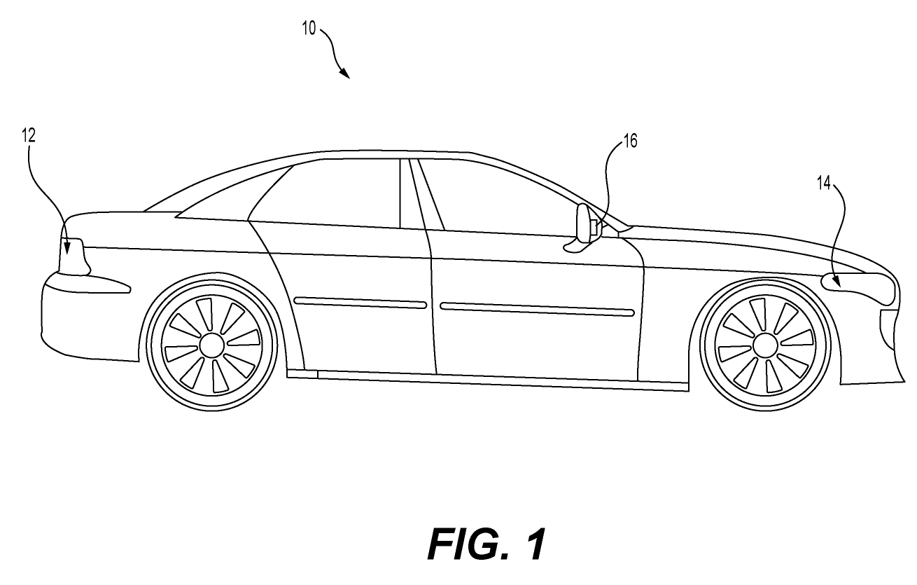

FIG. 1 shows a side view of a vehicle 10 including a taillight assembly 12 and a headlight assembly 14. Each of the taillight assembly 12 and the headlight assembly 14 may extend around an outside corner of the vehicle 10 and may incorporate various lighting elements, such as turn signal lights, marker lights, reverse indicators, etc. The vehicle 10 also includes an exterior rearview mirror housing 16 and a rear window 18. Either or both of the exterior rearview mirror housing 16 and/or the rear window 18 may also incorporate one or more lighting elements, such as turn signal lights, marker lights, reverse indicators, etc.

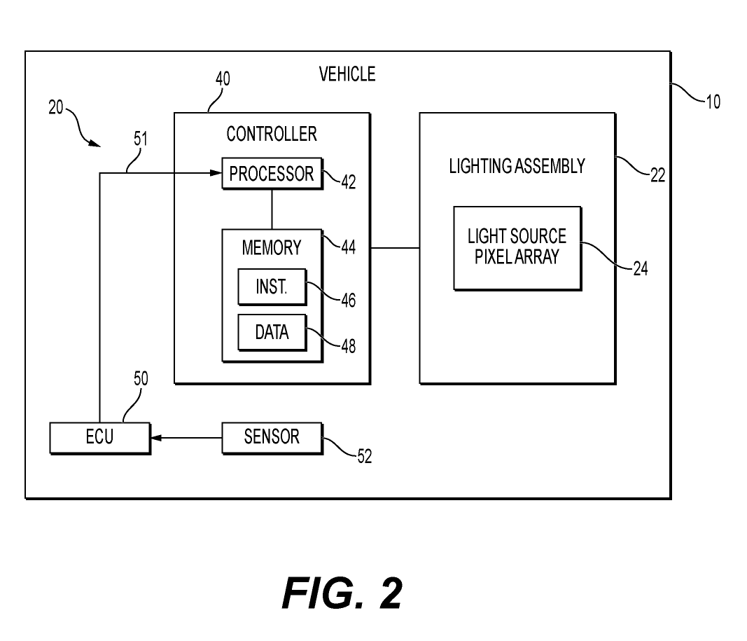

FIG. 2 shows a schematic block diagram of a vehicle 10 with a lighting system 20 of the present disclosure. The lighting system 20 includes a lighting assembly 22, which may be a part of an exterior lighting assembly, such as turn signal or other indicator for viewing by persons outside of the vehicle 10. Alternatively or additionally, the lighting assembly 22 may be used in an interior lighting assembly to present lighting effects that are visible to a driver and/or passengers inside the vehicle 10.

The lighting assembly 22 includes light source pixel array 24 with a 2-dimensional array of lighting elements. The lighting system 20 also includes a controller 40 in communication with light source pixel array 24. The controller 40 may be configured to control patterns of light generated by the light source pixel array 24. The controller 40 may provide signals to control a brightness level of one or more lighting elements within the light source pixel array 24. For example, the controller 40 may control brightness levels of each of the lighting elements using on/off signals and with pulse-width modulation (PWM) switching.

The controller 40 includes a processor 42 coupled to a storage memory 44. The storage memory 44 includes instruction storage 46 storing instructions, such as program code for execution by the processor 42. The storage memory 44 also includes data storage 48 for holding data for use by the processor 42. Alternatively, when using a zonal controller, the LED electronics may merely include a transceiver and matrix drivers for linear control of the brightness of each LED, and temperature sensors. In the zonal configuration the ECU, memory, and processor are located in the zonal controller, or incorporated as a part of the body control module. In this case the brightness settings, or frames of the graphics displayed on the light source pixel array are sent remotely via CAN, Ethernet, or other high speed communication interfaces such as LVDS.

The vehicle 10 also includes an electronic control unit (ECU) 50, such as a body control module, that is in functional communication with the processor 42 in the controller 40 of the lighting system 20. The vehicle 10 also includes a sensor 52 that is functionally connected to the ECU 50. The ECU 50 may receive a signal from the sensor 52, such as a turn signal indicator or a measured steering angle. The ECU 50 may communicate one or more control signals 51 to the controller 40 for controlling operation of the lighting system 20. For example, the ECU 50 may direct the controller 40 to cause the lighting assembly 22 to generate a particular lighting animation effect in response to a particular condition, such as a left-turn indicator or a right-turn indicator. In some embodiments, the sensor 52 may include a camera or sensing array for detecting a position of a user’s body. Alternatively, the camera sensor module may send signals to a combination of compute, graphics, and neural processing units for inference on how to best actuate the pixel lighting to properly illuminate the scene and deglare important objects in the environment so as to enhance machine vision in areas, or to deglare other biological and semiconductor sensors so that the illumination does not become distracting to oncoming or preceding vehicles and pedestrians. The sensor 52 may detect gestures, such as hand gestures by a person, such as a driver. Alternatively or additionally, the controller 40 may receive a control signal 51 directly from another external device, such as a turn signal switch (not shown).

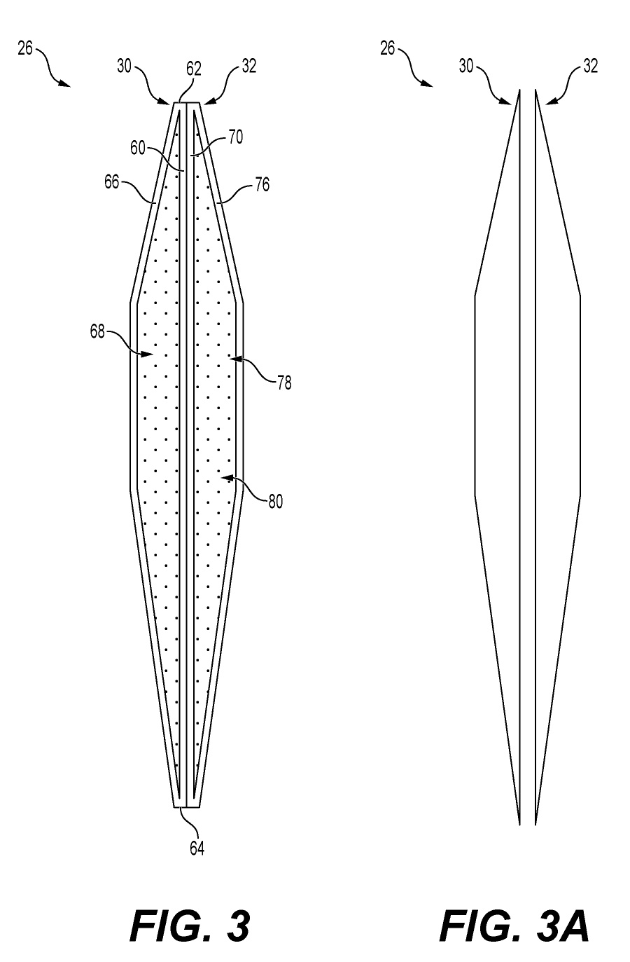

FIG. 3 shows a signal lamp assembly 26 for a vehicle 10. The signal lamp assembly 26 may include the lighting assembly 22. FIG. 3A shows the signal lamp assembly 26 of FIG. 3 in an unlit (hidden) state. The signal lamp assembly 26 may be used as at least a part of the taillight assembly or rear combination lamp which comprises functions such as tail, stop, turn, reverse, projection, and side-marker.

As shown, the signal lamp assembly 26 includes a first lighting portion 30 and a second lighting portion 32. The first lighting portion 30 may be selectively illuminated to provide a turn signal function, and the second lighting portion 32 may be selectively illuminated to provide a brake light function. However, either or both of the lighting portions 30, 32 may be used for other functions.

The first lighting portion 30 includes a first planar wall 60 extending vertically between a top end 62 and a bottom end 64. The first lighting portion 30 also includes a first curved wall 66 that joins the first planar wall 60 at the top end 62 and the bottom end 64 and curves away from the first planar wall 60 therebetween. A first array 68 of light emitting diode (LED) sources is disposed within the first lighting portion 30, between the first planar wall 60 and the first curved wall 66.

The second lighting portion 32 includes a second planar wall 70 extending vertically between the top end 62 and the bottom end 64 adjacent to the first planar wall 60 on a side thereof opposite of the first curved wall 66. The second lighting portion 32 also includes a second curved wall 76 that joins the second planar wall 70 at the top end 62 and the bottom end 64 and curves away from the second planar wall 70 therebetween. A second array 78 of LED sources is disposed within the second lighting portion 32, between the second planar wall 70 and the second curved wall 76.

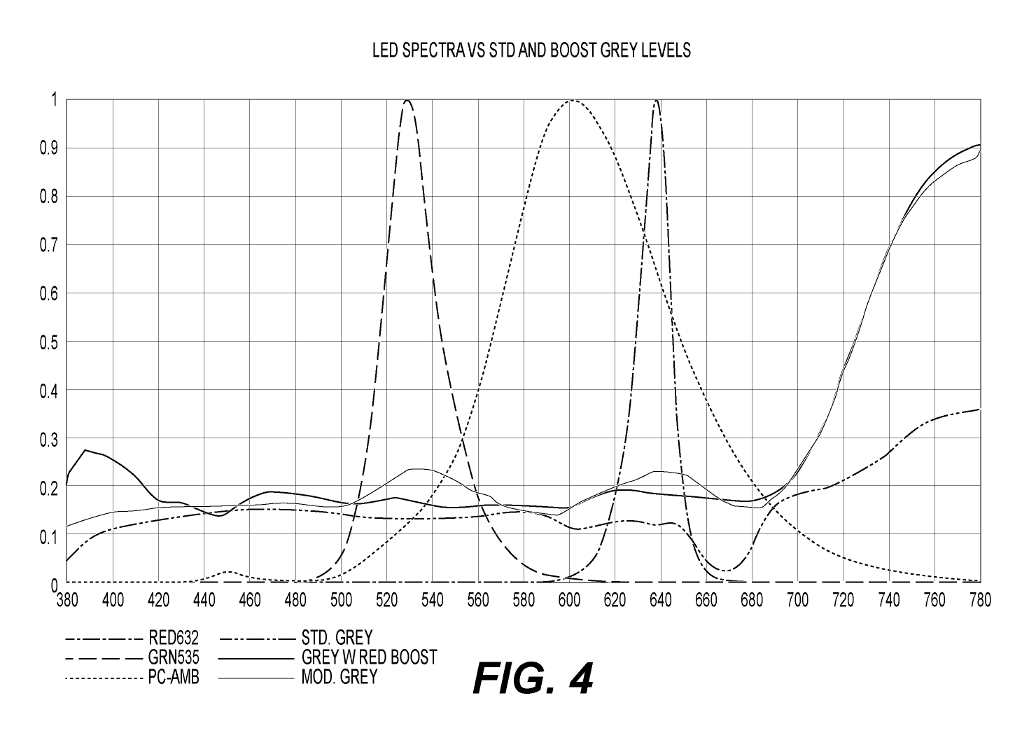

FIG. 4 shows a graph illustrating light spectra for various different light sources. The illustrated light sources include a 632 nm single-color red LED (RED632), a 535 nm single-color green LED (GRN535), a PC amber LED (PC-AMB), a standard grey light source (Std. Grey), a grey light source with additional boosted red (GREY W RED BOOST), and a modified grey light source generated by a lighting assembly of the present disclosure (MOD. GREY).

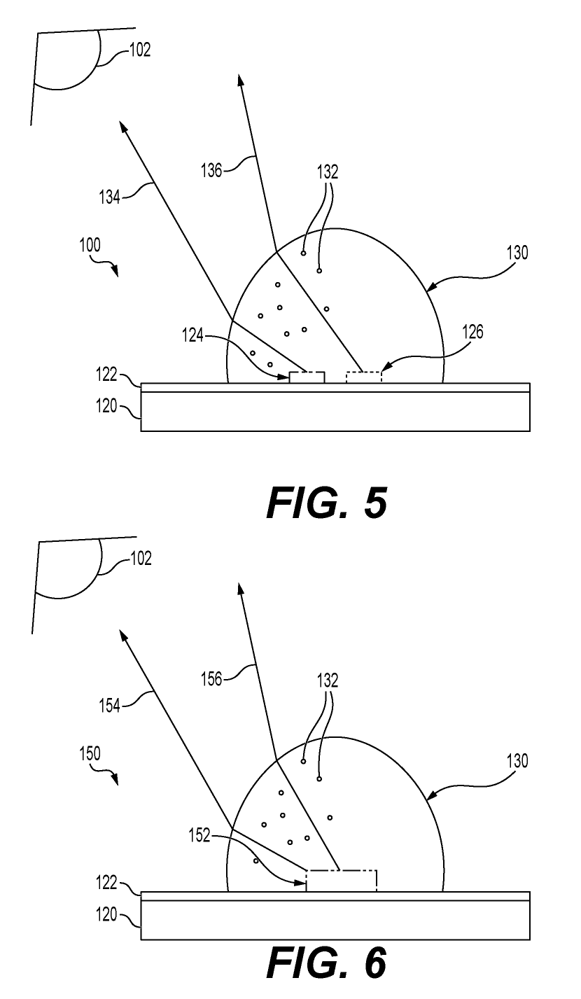

FIG. 5 shows a schematic diagram illustrating a cross-section of a first LED pixel assembly 100 emitting light rays 134, 136 for viewing by an observer 102. The first LED pixel assembly 100 includes a backplane 120, such as a printed circuit board (PCB) substrate, with an interconnect 122 disposed thereupon. A first LED device 124 overlies the interconnect 122 and is configured to emit first light rays 134 of red light. A second LED device 126 also overlies the interconnect 122 and is configured to emit second light rays 136 of green light. The light rays 134, 136 may be generated simultaneously to appear as an amber color.

A lenslet 130 of silicone material defines a generally hemispherical shape that surrounds each of the first LED device 124 and the second LED device 126. The lenslet 130 may have an oblong hemispherical shape as shown on FIG. 5, with a height perpendicular to the backplane 120 that is longer than a radius in a direction parallel to the backplane 120. Alternatively, the lenslet 130 may have a generally hemispherical shape or a shape of a different section of a sphere that is less than an entire hemisphere. Alternatively, the lenslet 130 may have a compressed hemispherical shape with a height that is less than a radius thereof. Each of the light rays 134, 136 is refracted upon exiting the lenslet 130. The lenslet 130 may also be called a droplet lens and may help to extract light, hide sapphire ambient light reflection, and provide collimation. Collimation lens shapes depart from a hemispherical shape to one which is more of a bullet shape and collimation converting a lambertian .3cd/lm to .6, or even 2cd/lm is possible at 30-degree beam distribution. A plurality of carbon black particles 132, Silicon Carbide, or Silicon Nitride particles are dispersed in the lenslet 130. The plurality of carbon black, Silicon Carbide, or Silicon Nitride particles 132 interact with light to provide a Lambertian scattering that can hide glint reflection that may otherwise be visible to the observer 102. In some embodiments, one or more filters may also be included to enhance light extraction from one or more of the LED devices 124, 126 or to mix the light emitted therefrom.

FIG. 6 shows a schematic diagram illustrating a cross-section of a second LED pixel assembly 150 emitting light rays 154, 156 for viewing by an observer 102. The second LED pixel assembly 150 may be similar or identical to the first LED pixel assembly 100, except for differences described herein. The second LED pixel assembly 150 is a monochromatic LED device 152 instead of the two separate LED devices 124, 126 of the first LED pixel assembly 100. The monochromatic LED device 152 overlies the interconnect 122 and is configured to emit third light rays 154 of red light, amber, or green fourth light rays 156. The second LED pixel assembly 150 also includes a lenslet 130 that surrounds the combined LED device 152, with a plurality of carbon black, Silicon Carbide, or Silicon Nitride particles 132 disposed therein.

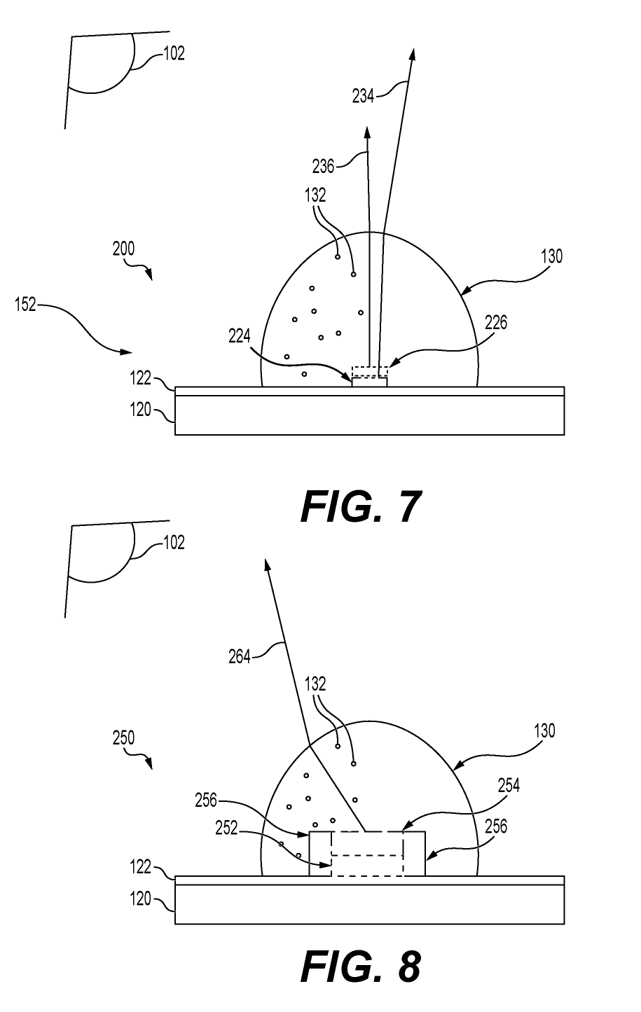

FIG. 7 shows a schematic diagram illustrating a cross-section of a third LED pixel assembly 200 emitting light rays 234, 236 for viewing by an observer 102. The third LED pixel assembly 200 may be similar or identical to the first LED pixel assembly 100, except for differences described herein. The third LED pixel assembly 200 includes a fourth LED device 224 that overlies the interconnect 122 and is configured to emit fifth light rays 234 of red light. The third LED pixel assembly 200 also includes a fifth LED device 226 that overlies the fourth LED device 224 and is configured to emit sixth light rays 234 of green light. The LED configuration includes a DBR or distributed Bragg reflector between LED 224 and green LED device 226. The distributed Bragg reflector is a stack of alternating high and low refractive index materials such as TiO2 (high refractive index) and SiO2 (low refractive index). The thickness of the layers can be 20 – 80nm and the number of alternating high and low refractive index pairs may be 2 – 16. The purpose of the DBR is to produce high reflectance in green while transmitting the red light emerging from the first LED device. Reflectance can approach 96% or higher for a well-designed DBR mirror. The light rays 234, 236 may be generated simultaneously to appear as an amber color. The third LED pixel assembly 200 also includes a lenslet 130 that surrounds the fourth LED device 224 and the fifth LED device 226, with a plurality of carbon black particles, Silicon Carbide, or Silicon Nitride particles 132 disposed therein.

FIG. 8 shows a schematic diagram illustrating a cross-section of a fourth LED pixel assembly 250 emitting light rays 264 for viewing by an observer 102. The fourth LED pixel assembly 250 may be similar or identical to the third LED pixel assembly 200, except for differences described herein. The fourth LED pixel assembly 250 includes a sixth LED device 252 that overlies the interconnect 122. A phosphor plate 254 overlies the sixth LED device 252 and is configured to emit sixth light rays 264 in response to receiving light emitted by the sixth LED device 252. The sixth light rays 264 may present an amber color. The fourth LED pixel assembly 250 also includes a recycler 256 with one or more light-reflective surfaces that surround corresponding peripheral edges of the sixth LED device 252 and the phosphor plate 254. The fourth LED pixel assembly 250 also includes a lenslet 130 that surrounds the sixth LED device 252 and the phosphor plate 254, with a plurality of carbon black particles, Silicon Carbide, or Silicon Nitride particles 132 disposed therein.

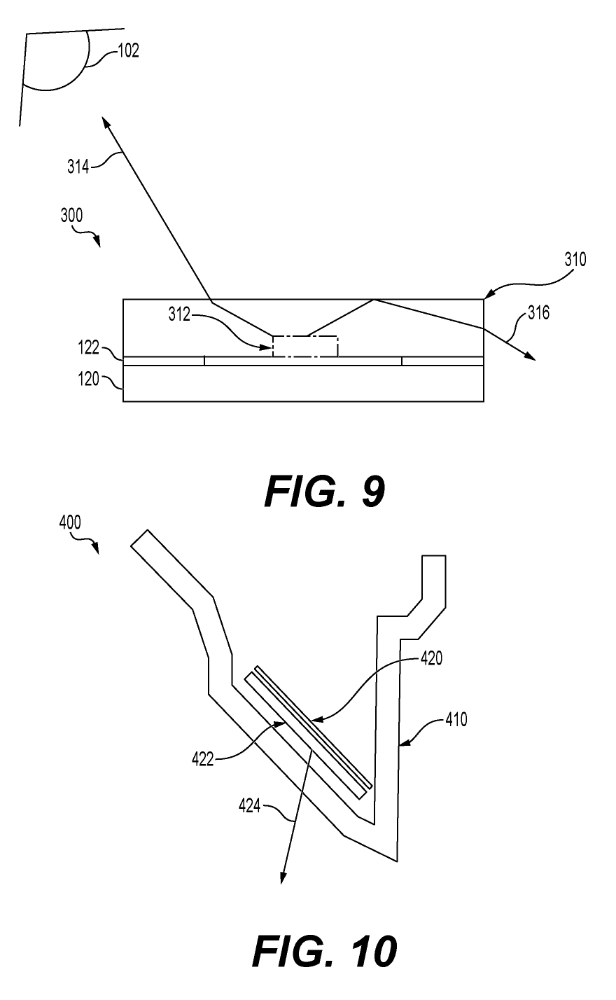

FIG. 9 shows a schematic diagram illustrating a cross-section of a fifth LED pixel assembly 300 emitting light rays 314 for viewing by an observer 102. The fifth LED pixel assembly 300 may be similar or identical to the first LED pixel assembly 100, except for differences described herein. The fifth LED pixel assembly 300 includes a seventh LED device 312 which overlies the interconnect 122 and which is encapsulated by a silicone encapsulant 310. Some light rays 314 are emitted by the seventh LED device 312 and refracted by the silicone encapsulant 310 before being visible to the observer 102. Other light rays 316 are reflected due to total internal reflection by the silicone encapsulant 310 and directed away from the observer 102. These light rays can be trapped and increase absorption losses

The fifth LED pixel assembly 300 shown on FIG. 9 may be referred to as an A-series part and includes a flat conformal coating structure overlying the seventh LED device 312. The second LED pixel assembly 150 shown on FIG. 6 may be referred to as a C-series part and has been shown to provide a 60% improvement in brightness when compared to the A-series parts, with the exception that black particles loading were reduced to <.01%. Alternative B-series parts having a design similar to the second LED pixel assembly 150, with a lenslet 130 and LEDs generating true red light at 622nm, were also evaluated. The alternative B-series parts were found to produce about 15% less brightness when compared to similar C-series parts. This was due to black particle loading of .2%, such as the second LED pixel assembly 150 shown on FIG. 6.

FIG. 10 shows a schematic diagram illustrating a cross-section of a lamp assembly 400 for a vehicle. The lamp assembly 400 may be used as or within the taillight assembly 12. The lamp assembly 400 includes a lamp cover 410 that encloses a light source array 420. The light source array 420 may include the includes light source pixel array 24 of the lighting assembly 22 described elsewhere in the present disclosure. The light source pixel array 24 may include lenslet structures which collimate the LED light to 20 – 40 degrees at full width at half maximum (FWHM). The collimation of the light is crucial to improve the effectiveness of the combination diffuser and light directing film which is located in close proximity to the light source pixel array 24. The lamp cover 410 defines a rake angle, such as a 20 to 30-degree angle relative to a direction of desired light projection. A combination diffuser and light directing film 422 is disposed between the light source array 420 and the lamp cover 410 and directs light rays 424 at a predetermined angle, such as 15 to 25-degrees relative to a plane of the light source array 420. The combination diffuser and light directing film 422 may, therefore, at least partially compensate for the rake angle to direct the emitted light in a desired direction, such as directly behind the vehicle 10. The construction of the combination diffuser and light directing film has small micro structures which resemble prisms in one direction with feature sizes of 50 – 200um and many 1000’s to millions of these micro prism structures are what redirect the light from directly outward to bending 15 – 25deg to improve intensity in the zones requires for legal stop and turn function. The micro structures in addition to including micro prisms may also include asymmetric bi-conic structures which can produce on a micro scale elliptical diffusion.

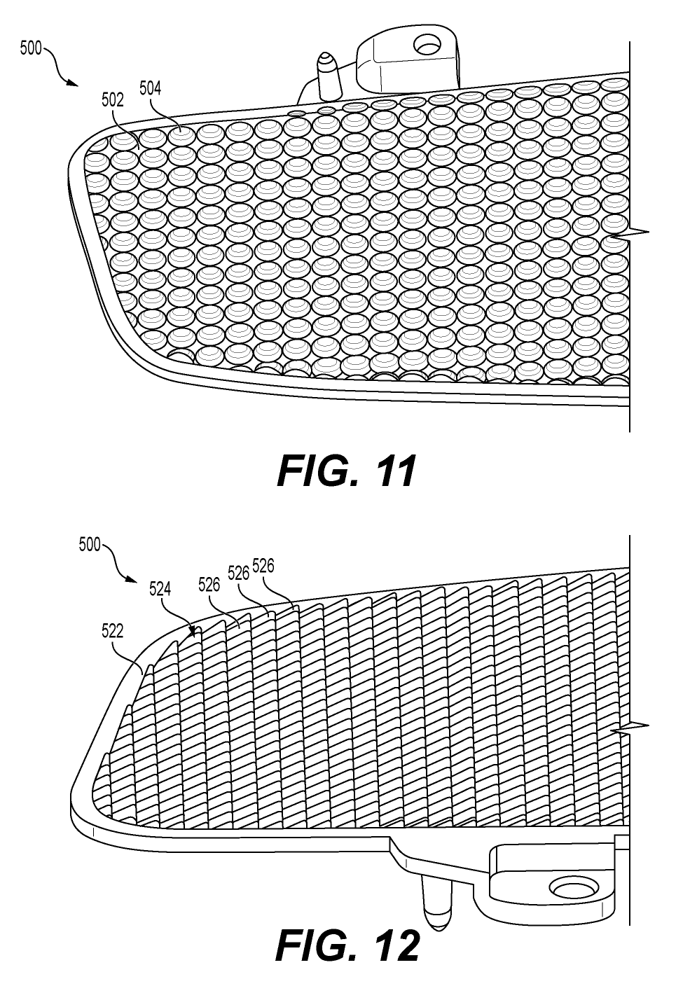

FIG. 11 shows a perspective view of a section of a secondary optic element 500, which may also be called a secondary optic layer. The secondary optic element 500 is shaped as a generally flat plate with a relatively small thickness that is one or more orders of magnitude smaller than each of its length and its width. FIG. 11 shows a rear surface 502 of the secondary optic element 500, with a plurality of convex collimators 504 protruding therefrom. Each of the convex collimators 504 is shaped as a spheroid section. The convex collimators 504 are tight-packed, adjoining one another to define vertical and horizontal rows that cover substantially all of the rear surface 502, except for a small border around a peripheral edge thereof. Each of the convex collimators is positioned directly above the position of the LED pixel.

FIG. 12 presents another perspective view of the secondary optic element 500, showing a front surface 522 opposite of the rear surface 502. As shown, the front surface 522 includes a prism surface 524 with a sawtooth shape. The prism surface 524 defines a plurality of periodic ridges 526 that extend in parallel lines at regular intervals and which are disposed adjacent to one another to define the sawtooth shaped cross-section. In the ZX cross section the saw tooth shaped prisms include profile1 curvature which can spread the light more strongly in one direction than in the other. When combined with light control curvature in the other direction ZY with profile2, the combination of the saw tooth prism with the two profiles of curvature produce the net result of beam direction of -15 degrees as well as converting a symmetric light distribution into a wider elliptical distribution with a ratio of 1.22:1. The power of the curve profiles on the sawtooth prisms can be tuned to provide more or less elliptic transformation of the beam as necessary. When these optical structures operate upon the incident light emerging from the convex collimators the net effect is to increase the light required in the regulatory intensity zones by up to 4 – 5x. See table comparison of with and without the prism lenslet The periodic ridges 526 each include an angled surface defining an acute angle relative to a general plane of the secondary optic element 500. Each of the periodic ridges 526 may be aligned with a row of the convex collimators 504 on the rear surface 502.

The secondary optic element 500 may be made of a single unitary piece, such as glass or a molded piece of polycarbonate resin thermoplastic or other optical polymer material, such as Poly(methyl methacrylate) (PMMA).

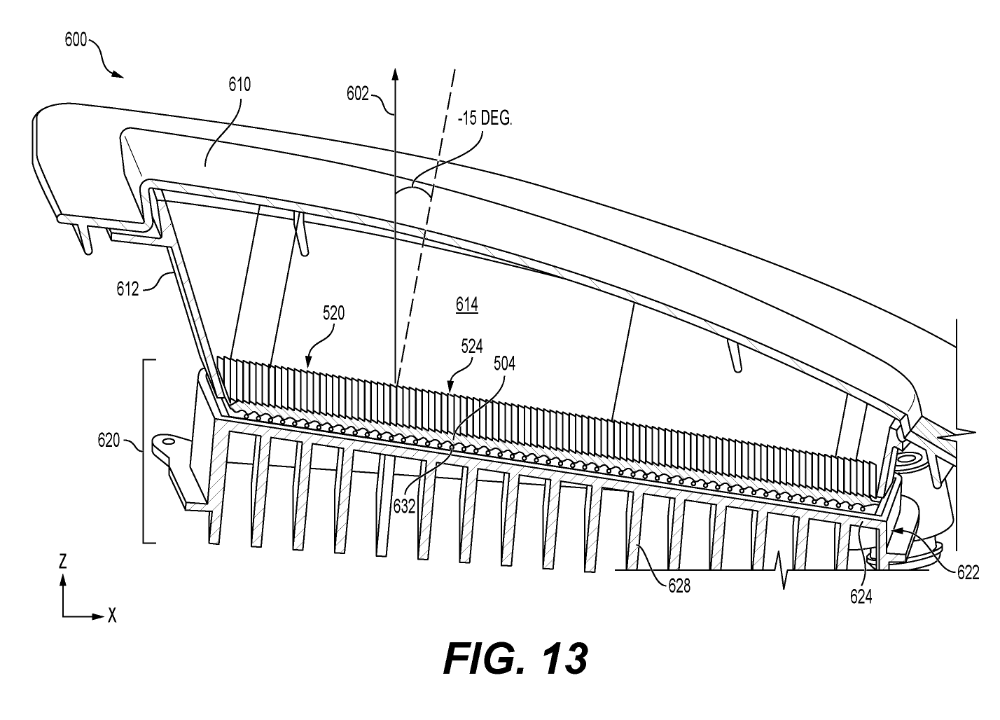

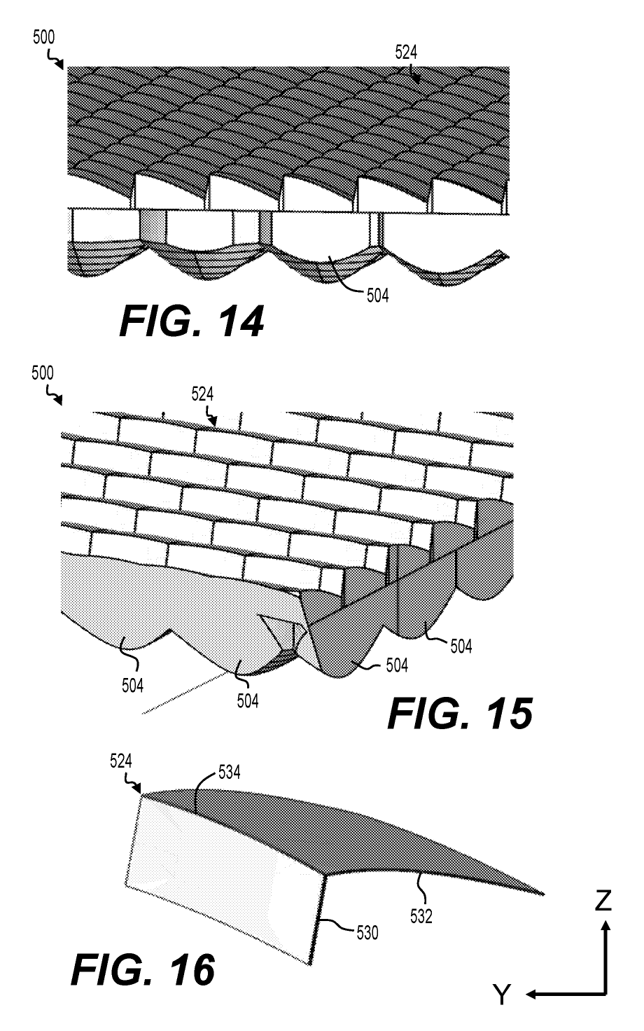

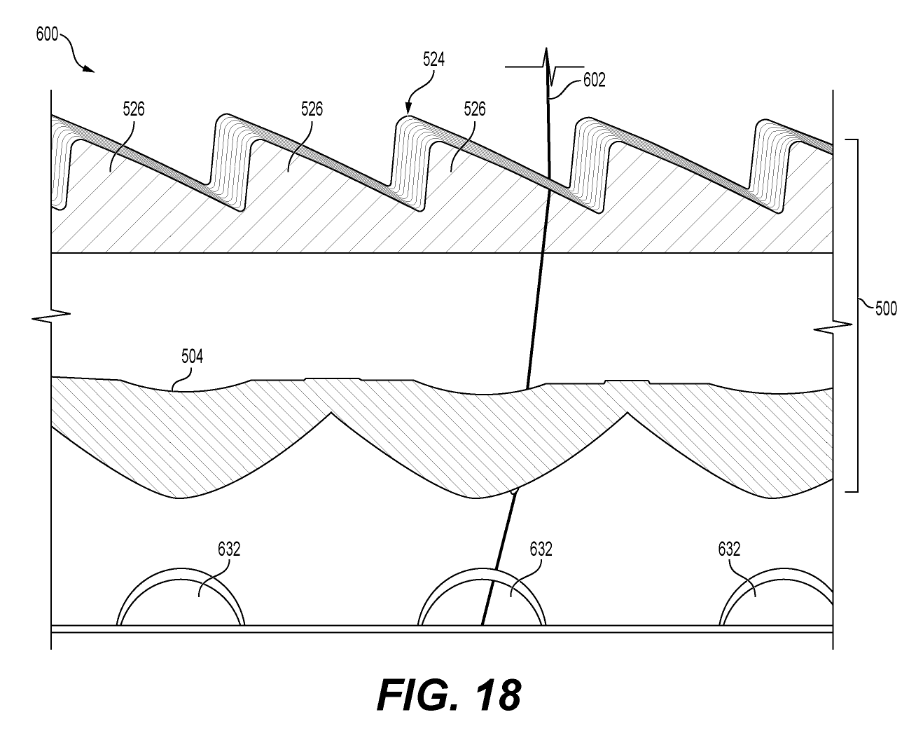

FIGS. 13-18 each cross-sectional views of an exterior lighting assembly 600 for a vehicle, with light rays 602 being generated therefrom. The exterior lighting assembly 600 may be used as at least a part of the taillight or rear combination light assembly 12. However, the exterior lighting assembly 600 may be used for other applications, such as in a headlight assembly 14 or in a daytime running, turn signal, or side marker light. FIG. 15 shows a light ray 602 being refracted by one of the convex collimators 504 and again when exiting the prism surface 524 of the secondary optic element 500. As shown, the light ray 602 is angled by -15-degrees. FIG. 18 shows details of an individual element that comprises the prism surface 524, including a prism height 530, a first profile 532 and a second profile 534. As shown, the first profile 532 and the second profile 534 are generally orthogonal to the prism height 530. As also shown, the first profile 532 and the second profile 534 each define slight curvature along their respective lengths. However, either or both of the first profile 532 and/or the second profile 534 may be straight.

As shown on FIG. 13, the exterior lighting assembly 600 includes a housing 612 having a generally tubular shape. An outer lens 610 encloses an axial end of the housing 612 to define an enclosed interior space 614 therein. The exterior lighting assembly 600 also includes a lamp assembly 620 for generating light.

The lamp assembly 620 includes a base assembly 622 which may serve several different functions, including providing structural rigidity, heat dissipation, and/or for mounting the lamp assembly 620 to the housing 612 and/or to another structure of the vehicle 10. The base assembly 622 may be made of metal, such as aluminum and/or steel. In some embodiments, the base assembly may be made from a unitary piece of metal with various features integrally formed by casting, machining, or by another process. The base assembly 622 includes a baseplate 624 having a generally flat planar shape. The base assembly 622 also includes a plurality of fins 628 for dissipating heat. The fins 628 are integrally formed with or otherwise attached to the baseplate 624 and extend therefrom, away from the housing 612.

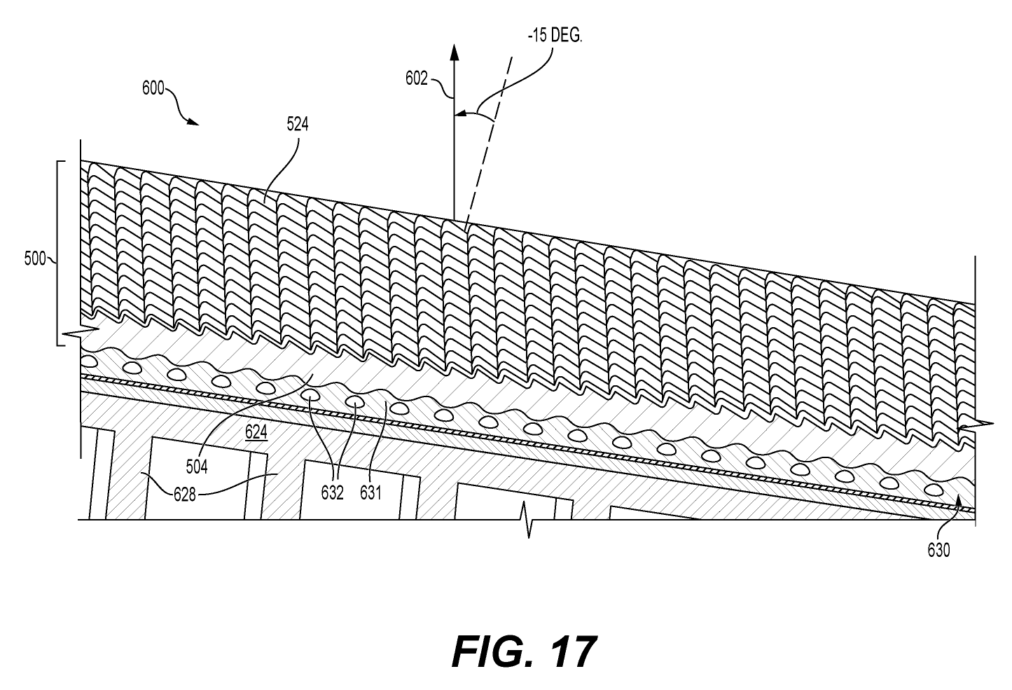

The lamp assembly 620 also includes a printed circuit board (PCB) 630 having a generally flat planar shape that overlies the baseplate 624 and is in thermal contact therewith. The PCB 630 may include the backplane 120 and the interconnect 122. The PCB 630 defines an upper surface 631 that faces toward the outer lens 610. The lamp assembly 620 also includes an array of pixel light sources 632 disposed the upper surface 631 of the PCB 630. Each of the pixel light sources 632 includes at least one LED device and a lenslet encapsulating the at least one LED device. Each of the pixel light sources 632 may include, for example, any one of the LED pixel assemblies 100, 150, 200, 250 described above. FIGS. 13 and 17 show only one row of the pixel light sources 632. However, it should be understood that the array of pixel light sources 632 includes several additional rows of the pixel light sources 632 behind that one row shown on the FIGs.

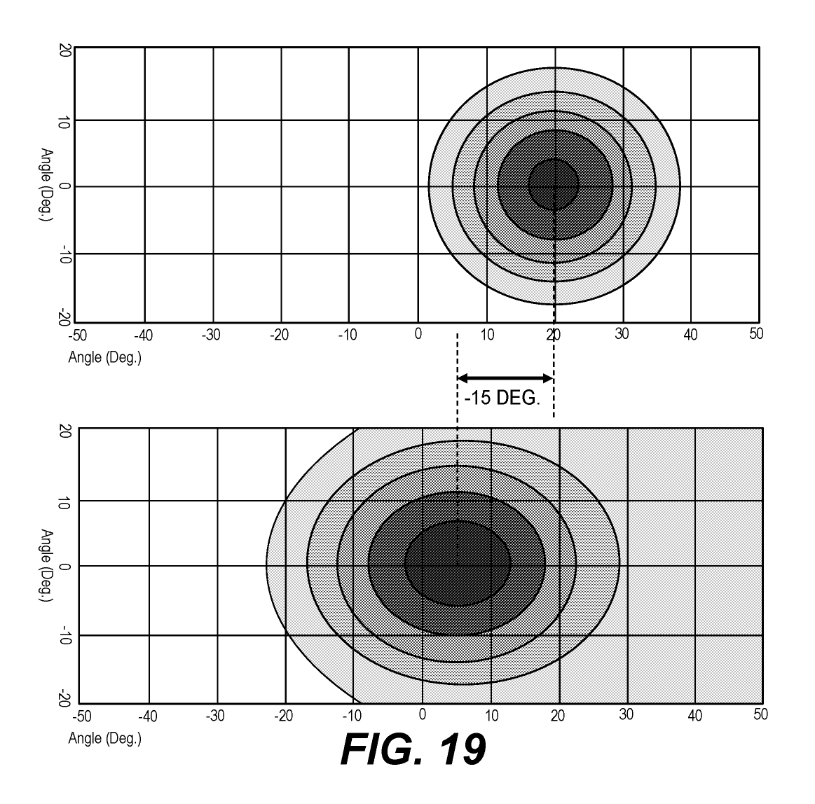

FIG. 19 shows beam profiles generated by the exterior lighting assembly 600, without and with the prism surface 524 of the secondary optic element 500. As indicated, the inclusion of the prism surface 524 causes the beam profile to be shifted horizontally by -15 degrees. The inclusion of the prism surface 524 also adds ellipticity to the beam profile by a factor of about 1.22:1. This increased ellipticity spreads the generated light over a wider field to provide a more desirable pattern of illumination.

The lamp assembly 620 also includes the secondary optic element 500 overlying the array of pixel light sources 632. As shown, the secondary optic element 500 is closely spaced from the pixel light sources 632. This close spacing may provide for a substantial majority of light emitted from each of the pixel light sources 632 to be directed into a corresponding one of the convex collimators 504 directly overhead. In some embodiments, the secondary optic element 500 may be spaced apart from the pixel light sources 632 by a distance of less than five millimeters. In some embodiments, the secondary optic element 500 may be spaced apart from the pixel light sources 632 by a distance of less than 2 millimeters. In some embodiments, the secondary optic element 500 may be spaced apart from the pixel light sources 632 by a distance of less than 1 millimeter. However, the actual spacing may depend on a particular application and other considerations, such as thermal expansion, to ensure that the secondary optic element 500 does not contact the pixel light sources 632 under normal operating conditions, which can cause unwanted wear, noise, and/or vibration.

The present disclosure provides an exterior lighting assembly for a vehicle. The exterior lighting assembly includes: an array of pixel light sources disposed on a backplane, a secondary optic element overlying the array of pixel light sources, and an outer lens overlying and spaced apart from the secondary optic element. Each of the pixel light sources includes at least one LED device and a lenslet encapsulating the at least one LED device.

In some embodiments, the secondary optic element is shaped as a generally flat plate and is spaced apart from the array of pixel light sources by a distance of not more than five millimeters.

In some embodiments, the secondary optic element includes a plurality of convex collimators extending toward the array of pixel light sources, wherein each convex collimator overlies a corresponding lenslet of the array of pixel light sources. For example, the secondary optic element may take the form of the secondary optic element 500 shown on FIGS. 11 and 13-15 and described above. Additionally or alternatively, the secondary optic element may include another optical element, such as the diffuser 422 shown on FIG. 10 and described above.

In some embodiments, each convex collimator of the plurality of convex collimators is shaped as a spheroid section and wherein the plurality of convex collimators each adjoin adjacent ones of the convex collimators to cover substantially all of a rear surface of the secondary optic element.

In some embodiments, the secondary optic element further includes a prism surface opposite of the plurality of convex collimators, wherein the prism surface includes a plurality of periodic ridges each defining an angled surface.

In some embodiments, the prism surface defines a sawtooth shape with the plurality of periodic ridges each disposed adjacent to one another, as well as profile curves which convert the symmetrical light emerging from the convex collimators into an elliptical beam.

In some embodiments, the exterior lighting assembly also includes a controller in functional communication with the array of pixel light sources. The controller may be programmed or otherwise configured to: receive a control signal from an external source, and command, in response to the control signal, the array of pixel light sources to change at least one of: a color, an intensity, or a pattern of light produced therefrom.

In some embodiments, the lenslet is made of a silicone material.

In some embodiments, the exterior lighting assembly includes a plurality of particles disposed in the lenslet. The plurality of particles may interact with light to provide a Lambertian scattering.

In some embodiments the lenslet defines an oblong hemispherical shape with a height perpendicular to the backplane that is longer than a radius in a direction parallel to the backplane.

In some embodiments each of the pixel light sources further includes a recycler with one or more light-reflective surfaces that surround corresponding peripheral edges of the at least one LED device.

In some embodiments the at least one LED device is configured to generate at least two different colors of light.

In some embodiments the at least one LED device includes a single LED device that is configured to generate monochromatic light.

In some embodiments the at least one LED device includes two independent LED devices each configured to generate a corresponding color of light, and wherein the corresponding colors of light are each different.

In some embodiments the exterior lighting assembly is configured as a taillight assembly for attachment to a rear portion of the vehicle.

The present disclosure also provides a taillight assembly for a vehicle. The taillight assembly includes: an array of pixel light sources disposed on a backplane, and a secondary optic element overlying the array of pixel light sources. Each of the pixel light sources includes at least one LED device and a lenslet encapsulating the at least one LED device.

In some embodiments, the taillight assembly also includes: a housing having a generally tubular shape; an outer lens enclosing an axial end of the housing; and a lamp assembly including the array of pixel light sources and which covers another axial end of the housing opposite from the outer lens.

In some embodiments, the lamp assembly further includes a baseplate extending along the backplane opposite of the array of pixel light sources and configured to remove heat therefrom.

In some embodiments, the taillight assembly also includes a plurality of fins attached to the baseplate and extending away from the backplane for dissipating heat.

In some embodiments, the taillight assembly also includes a controller in functional communication with the array of pixel light sources. The controller may be configured command the array of pixel light sources to change at least one of: a color, an intensity, or a pattern of light produced therefrom.

The system, methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. One or more steps or functions of the provided methods and/or processes may be realized in one or more microprocessors, microcontrollers, embedded microcontrollers, programmable digital signal processors or other programmable devices, along with internal and/or external memory. One or more steps or functions of the provided methods and/or processes may also, or alternatively, be embodied in an application specific integrated circuit, a programmable gate array, programmable array logic, or any other device or combination of devices that may be configured to process electronic signals. It will further be appreciated that one or more of the steps or functions of the provided methods and/or processes may be realized as a computer executable code capable of being stored on a machine readable medium and/or executed by one or more computing hardware devices.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors, processor architectures, combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionalities may be integrated into a dedicated, standalone device or other hardware. In another aspect, the means for performing the steps associated with the processes described above may include any of the hardware and/or software described above. All such permutations and combinations are intended to fall within the scope of the present disclosure.

A processor, controller, microcontroller, electronic control unit, or other computing device or devices should be understood to mean any combination of one or more computing hardware devices, which may operate independently and/or in coordination to perform one or more computing or other data processing functions.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An exterior lighting assembly for a vehicle, comprising:
an array of pixel light sources disposed on a backplane, each of the pixel light sources including at least one LED device and a lenslet encapsulating the at least one LED device;
a secondary optic element overlying the array of pixel light sources; and
an outer lens overlying and spaced apart from the secondary optic element.

2. The exterior lighting assembly of claim 1, wherein the secondary optic element is shaped as a generally flat plate and is spaced apart from the array of pixel light sources by a distance of not more than five millimeters.

3. The exterior lighting assembly of claim 1, wherein the secondary optic element includes a plurality of convex collimators extending toward the array of pixel light sources, wherein each convex collimator overlies a corresponding lenslet of the array of pixel light sources.

4. The exterior lighting assembly of claim 3, wherein each convex collimator of the plurality of convex collimators is shaped as a spheroid section and wherein the plurality of convex collimators each adjoin adjacent ones of the convex collimators to cover substantially all of a rear surface of the secondary optic element.

5. The exterior lighting assembly of claim 3, wherein the secondary optic element further includes a prism surface opposite of the plurality of convex collimators, wherein the prism surface includes a plurality of periodic ridges each defining an angled surface.

6. The exterior lighting assembly of claim 5, wherein the prism surface defines a sawtooth shape with the plurality of periodic ridges each disposed adjacent to one another.

7. The exterior lighting assembly of claim 1, further including a controller in functional communication with the array of pixel light sources,
wherein the controller is configured to:
receive a control signal from an external source, and
command, in response to the control signal, the array of pixel light sources to change at least one of: a color, an intensity, or a pattern of light produced therefrom.

8. The exterior lighting assembly of claim 1, wherein the lenslet is made of a silicone material.

9. The exterior lighting assembly of claim 1, further including a plurality of particles disposed in the lenslet and configured to interact with light to provide a Lambertian scattering.

10. The exterior lighting assembly of claim 1, wherein the lenslet defines an oblong hemispherical shape with a height perpendicular to the backplane that is longer than a radius in a direction parallel to the backplane.

11. The exterior lighting assembly of claim 1, wherein each of the pixel light sources further includes a recycler with one or more light-reflective surfaces that surround corresponding peripheral edges of the at least one LED device.

12. The exterior lighting assembly of claim 1, wherein the at least one LED device is configured to generate at least two different colors of light.

13. The exterior lighting assembly of claim 12, wherein the at least one LED device includes a single LED device that is configured to generate monochromatic light.

14. The exterior lighting assembly of claim 1, wherein the at least one LED device includes two independent LED devices each configured to generate a corresponding color of light, and wherein the corresponding colors of light are each different.

15. The exterior lighting assembly of claim 1, wherein the exterior lighting assembly is configured as a taillight assembly for attachment to a rear portion of the vehicle.

16. A taillight assembly for a vehicle, comprising:
an array of pixel light sources disposed on a backplane, each of the pixel light sources including at least one LED device and a lenslet encapsulating the at least one LED device; and
a secondary optic element overlying the array of pixel light sources.

17. The taillight assembly of claim 16, further comprising:
a housing having a generally tubular shape;
an outer lens enclosing an axial end of the housing; and
a lamp assembly including the array of pixel light sources and which covers another axial end of the housing opposite from the outer lens.

18. The taillight assembly of claim 17, wherein the lamp assembly further includes a baseplate extending along the backplane, opposite of the array of pixel light sources and configured to remove heat therefrom.

19. The taillight assembly of claim 18, further including a plurality of fins attached to the baseplate and extending away from the backplane for dissipating heat.

20. The taillight assembly of claim 16, further comprising a controller in functional communication with the array of pixel light sources, wherein the controller is configured command the array of pixel light sources to change at least one of: a color, an intensity, or a pattern of light produced therefrom.
